(19) United States
(12) Patent Application Publication
(10) Pub. No.: US 2012/0275724 A1
(43) Pub. Date: Nov. 1, 2012

(54) IMAGE PROCESSING APPARATUS, IMAGE PROCESSING METHOD, AND PROGRAM

(75) Inventor: Masafumi Wakazono, Kanagawa (JP)

(73) Assignee: Sony Corporation, Tokyo (JP)

(21) Appl. No.: 13/451,236

(22) Filed: Apr. 19, 2012

(30) Foreign Application Priority Data
Apr. 26, 2011 (JP) 2011-098443

(51) Int. Cl. G06K 9/32

(52) U.S. Cl. 382/298

(57) ABSTRACT

There is provided an image processing apparatus that includes a pre-enlargement image processing unit that processes an image signal, based on one or more flow vectors corresponding to the image signal, and an enlargement processing unit that enlarges an image indicated by an image signal processed by the pre-enlargement image processing unit, based on the one or more flow vectors.

### BACKGROUND

The present disclosure relates to an image processing apparatus, an image processing method, and a program.

In recent years, there are proposed image processing methods that define a set of flow vectors to each region of an image which an image signal to be processed indicates and that performs an image process based on the flow vectors to the image signal. By performing the image process based on the flow vectors to the image signal as described above, it becomes possible to give a painterly effect (an effect of brush strokes) to an image that is indicated by the image signal as if an artist painter had drawn the image, for example.

As techniques that relate to an image process corresponding to a set of flow vectors, there are a technique described in Japanese Patent Application Laid-Open No. 2002-505784 (U.S. Pat. No. 6,011,536) that gives brush stroke patterns (corresponding to the flow vector) to an image, and techniques that are described in the following non-patent literatures:

1. Henry Kang, Seungyong Lee, Charles K. Chui, “Flow-based Image Abstraction”, IEEE TRANSACTIONS ON VISUALIZATION AND COMPUTER GRAPHICS, VOL 15, NO. 1, JANUARY/FEBRUARY 2009, p. 62-76.

2. Jan Eric Kyprianidis, Henry Kang, “Image and Video Abstraction by Cocherence-Enhancing Filtering”, EUROGRAPHICS 2011, Volume 30(2011), Number 2.

3. Cabral, B. and Leedom, L. C. “Imaging vector fields using line integral convolution”, Proceedings of the 20th annual conference on Computer graphics and interactive techniques, 1993, p. 263-270.

### SUMMARY

By using the techniques relating to an image process based on the flow vectors as described in Japanese Patent Application Laid-Open No. 2002-505784 (U.S. Pat. No. 6,011,536) and the non-patent literatures 1 to 3 as described above, for example, it is possible to convert an image that an image signal to be processed indicates into an image (hereinafter, also “a painterly image”) to which an effect of brush strokes is added as if an artist painter had drawn the image. When the technique relating to an image process based on the flow vectors as described above is used, for example, a calculation quantity that is necessary to convert an image indicated by an image signal to be processed into a painterly image becomes large. Therefore, when the technique relating to an image process based on the flow vectors as described above is used, for example, a processing time becomes longer when a number of pixels becomes larger.

In the present disclosure, there are proposed an image processing apparatus, an image processing method, and a program that are new and improved, capable of converting an image that is indicated by an image signal to be processed into an image that has a larger number of pixels than that of an image processed based on the flow vectors.

According to an embodiment of the present disclosure, there is provided an image processing apparatus including a pre-enlargement image processing unit that processes an image signal, based on one or more flow vectors corresponding to the image signal, and an enlargement processing unit that enlarges an image indicated by an image signal processed by the pre-enlargement image processing unit, based on the one or more flow vectors.

According to another embodiment of the present disclosure, there is provided an image processing method including processing an image signal, based on one or more flow vectors corresponding to the image signal, and enlarging an image indicated by a processed image signal, based on the one or more flow vectors.

According to another embodiment of the present disclosure, there is provided a program that causes a computer to execute processing an image signal, based on one or more flow vectors corresponding to the image signal, and enlarging an image indicated by a processed image signal, based on the one or more flow vectors.

According to the present disclosure, an image that an image signal to be processed can be converted into an image that has a larger number of pixels than that of an image processed based on the flow vector.

### BRIEF DESCRIPTION OF THE DRAWINGS

FIG. 1 is a block diagram showing an example of a configuration of an image processing apparatus according to a first embodiment;

FIG. 2 is a flowchart showing an example of a process performed by the image processing apparatus according to the first embodiment;

FIG. 3 is an explanatory diagram showing an example of a configuration of a detecting unit that is included in the image processing apparatus according to the first embodiment;

FIG. 4 is a flowchart showing an example of a process performed by the detecting unit that is included in the image processing apparatus according to the first embodiment;

FIG. 5 is an explanatory diagram showing an example of a configuration of an image processing unit that is included in the image processing apparatus according to the first embodiment;

FIG. 6 is a flowchart showing an example of a process performed by the image processing unit that is included in the image processing apparatus according to the first embodiment;

FIG. 7 is an explanatory diagram showing an example of a configuration of an enlargement processing unit that is included in the image processing apparatus according to the first embodiment;

FIGS. 8A to 8D are explanatory diagrams showing an example of an interpolation process of a flow vector performed by the enlargement processing unit that is included in the image processing apparatus according to the first embodiment;

FIG. 9 is a flowchart showing an example of a process performed by the enlargement processing unit that is included in the image processing apparatus according to the first embodiment;

FIG. 10 is a block diagram showing an example of a configuration of an image processing apparatus according to a second embodiment;

FIG. 11 is an explanatory diagram showing an example of a configuration of an enlargement processing unit that is included in the image processing apparatus according to the second embodiment;

FIG. 12 is a flowchart showing an example of a process performed by the enlargement processing unit that is included in the image processing apparatus according to the second embodiment;

FIG. 13 is a flowchart showing an example of a process in the image processing apparatus according to the second embodiment;

FIG. 14 is a block diagram showing an example of a configuration of an image processing apparatus according to a third embodiment; and

FIG. 15 is a flowchart showing an example of a process of a flow-vector updating unit that is included in an image processing apparatus according to a third embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Explanation is performed below in the following order.

1. An image processing method according to the present embodiment

2. An image processing apparatus according to the present embodiment

3. A program according to the present embodiment

### An Image Processing Method According to the Present Embodiment

Before explaining a configuration of an image processing apparatus according to a present embodiment, an image processing method according to the present embodiment is explained. It is explained below by assuming that the image processing apparatus according to the present embodiment performs the image processing method according to the present embodiment.

The explanation is performed below by assuming that the image processing apparatus according to the present embodiment processes an image signal that indicates an image (a still image or a moving image, and this is hereinafter similarly applied). In the following explanation, an image signal processed by the image processing apparatus according to the present embodiment is also expressed as “input image signal”, and an image signal that has been processed by the image processing apparatus according to the present embodiment is also expressed as “output image signal.”

As an input image signal according to the present embodiment, there is an image signal that is obtained by the image processing apparatus according to the present embodiment as a result of receiving (directly, or indirectly via a set-top box and the like) a broadcast wave transmitted from a television tower and the like and decoding the received broadcast wave, for example. The image processing apparatus according to the present embodiment can also receive an image signal that is transmitted from an external apparatus via a network (or directly), for example, and process the received image signal as an input image signal. The image processing apparatus according to the present embodiment can be arranged to process, as an input image signal, an image signal that is obtained by decoding image data that is stored in a storage unit (to be described later) and in an external recoding medium that is detachable from the image processing apparatus, for example. The image processing apparatus according to the present embodiment can be also arranged to process an image signal that corresponds to an image picked up by an image pickup unit (to be described later), as an input image signal, for example, when the image processing apparatus according to the present embodiment includes the image pickup unit (to be described later) that can pick up an image, that is, when the image processing apparatus according to the present embodiment functions as the image pickup apparatus.

As described above, as a technique that converts an image indicated by an image signal to be processed into a painterly image, there are those disclosed in Japanese Patent Application Laid-Open No. 2002-505784 (U.S. Pat. No. 6,011,536) and in the non-patent literatures as described above. However, when the techniques relating to the image process based on flow vectors as described above are used, for example, a calculation quantity that is necessary to perform the process also increases when a number of pixels increases. Therefore, when the number of pixels increases, a processing time also becomes long. Accordingly, when an image processing apparatus is used to which the technique relating to the image process based o flow vectors as described above is applied, for example, there is a risk that a user's waiting time for the process using the image processing apparatus increases along with an increase of a time necessary to perform the image process based on flow vectors. Consequently, there is a possibility that convenience for the user reduces, when the technique relating to the image process based on flow vectors as described above is used, for example.

As a process to be performed to an image signal, a process of enlarging an image that is indicated by the image signal to be processed is often performed. As a technique for enlarging an image, there are a technique that is disclosed in Japanese Patent No. 4150947, and techniques that are described in the following non-patent literatures:

4. Wing-Shan Tam, Chi-Wah Kok, Wan-Chi Siu, “A MODIFIED EDGE DIRECTED INTERPOLATION FOR IMAGES”, 17th European Signal Processing Conference (EUSIPCO 2009), Aug. 24-28, 2009, p. 283-287).

5. Xin Li Micheael T. Orchard, “New Edge-Directed Interpolation”, IEEE TRANSACTIONS ON IMAGE PROCESSING, VOL 10, NO. 10, OCTOBER 2001, p 1521-1527.

As a method for obtaining an image that has a larger number of pixels than that of an image processed based on a set of flow vectors while restricting an increase of a calculation quantity necessary to perform an image process based on the flow vectors, there is a method for enlarging an image after processing the image based on the flow vectors, by performing the image process based on the flow vectors to an image that has a smaller number of pixels than a desired number of pixels, for example. When this method is used, it becomes possible to shorten a time necessary to perform an image process based on the flow vectors, by performing the image process based on the flow vectors to the image having a smaller number of pixels. Further, instead of a simple enlargement process, when a process that relates to the technique relating to enlargement of an image as described in Japanese Patent No. 4150947 and in the non-patent literatures 4 and 5, for example, is performed to an image after being processed based on the flow vectors, it becomes possible to prevent degradation of image quality such as blur in an image, for example, that has a possibility of occurrence when a simple enlargement process is performed to the image.

Therefore, by using the method described above, there is a possibility that an image indicated by an image signal to be processed can be converted into an image that has a larger number of pixels than that of an image that is processed based on the flow vectors, while reducing a time that is necessary to perform the image process based on the flow vectors.

However, according to the techniques relating to enlargement of an image as described in Japanese Patent No. 4150947 and in the non-patent literatures 4 and 5, for example, a detection process of a direction component for detecting a direction component of an image is necessary. Therefore, in a case where the method described above is used, there is a risk that a time necessary for a total process is not able to be shortened as expected (or increase), because it takes time to perform a detection process of a direction component of an image, even when the time necessary to perform the image process based on a flow vector can be shortened.

Further, when the technique relating to enlargement of an image as described in Japanese Patent No. 4150947 and in the non-patent literatures 4 and 5 is used, for example, there is a risk that a direction component of an image is not able to be correctly detected, by an influence of noise and the like contained in the image to be enlarged. When the direction component of the image is not able to be correctly detected as described above, a preferable interpolation result is not able to be obtained in the enlargement process. Further, when the technique relating to the enlargement process as described above, for example, is used for an image that is processed based on flow vectors of an image obtained by converting an image into a painterly image, for example, there is a possibility that a direction component corresponding to the flow vectors is not able to be detected, for example. Therefore, there is a risk that the image quality is degradated when the technique relating to the enlargement process as described above is used, for example.

As described above, even when the method described above is used, it is not necessarily possible to convert an image indicated by an image signal to be processed into an image that has a larger number of pixels than that of an image that is processed based on flow vectors while shortening a processing time and preventing degradation of image quality.

### An Outline of the Image Processing Method According to the Present Embodiment

Therefore, the image processing apparatus according to the present embodiment performs an image process (a pre-enlargement image process) based on a set of flow vectors corresponding to the image indicated by an image signal to be processed. Then, the image processing apparatus according to the present embodiment enlarges the image processed based on the flow vectors to an image that has a desired number of pixels, by using the flow vectors that is used in the image process based on the flow vectors (an enlargement process).

In this case, the flow vectors corresponding to the image that the image signal to be processed according to the present embodiment indicates refers to a vector of which a direction is defined for each pixel or for each region including plural pixels, for example. The flow vector according to the present embodiment can be a vector calculated based on an image signal, or can be a vector that is set based on a user operation, for example. As the flow vector according to the present embodiment, it is a vector of unit norm, for example. It is needless to mention that the flow vector according to the present embodiment is not limited to the vector of unit norm. The flow vector according to the present embodiment can be also arranged to be expressed by a scalar quantity by expressing the flow vector by an angle (an angle in a counterclockwise direction, for example) between a horizontal direction of an image and the flow vector, instead of expressing the flow vector as a vector.

As described above, the image processing apparatus according to the present embodiment can convert an image indicated by an image signal to be processed into an image that has a larger number of pixels than that of an image processed based on the flow vector, by performing (1) the image process based on flow vectors and (2) the expansion process, as the process according to the image processing method according to the present embodiment.

The image processing apparatus according to the present embodiment performs an image process based on a flow vector, to an image having a smaller number of pixels than that of an image having a desired number of pixels that is obtained by the process (the enlargement process) of (2), in the process (the image process based on flow vectors) of (1). Therefore, the image processing apparatus according to the present embodiment can further reduce a calculation quantity that is necessary to perform the image process based on a flow vector, in a similar manner to that when the method described above is used. Consequently, the time necessary to perform the image process based on the flow vector can be further reduced.

The image processing apparatus according to the present embodiment also performs a process by using a set of flow vectors that is used in the process (the image process based on flow vectors) of (1), in the process (the enlargement process) of (2). Therefore, the image processing apparatus according to the present embodiment is not necessary to newly detect a direction component of an image, unlike a case where the technique relating to the enlargement process as described in Japanese Patent No. 4150947 and in the non-patent literatures 4 and 5 is used, for example. Consequently, a processing time is not extended to detect a direction component of the image, unlike a case where the technique relating to the enlargement process is used. Because the image processing apparatus according to the present embodiment performs the enlargement process by using the flow vectors that is used in the process of (1), there is no risk of degradation of image quality, unlike a case where the technique relating to the enlargement process as described above is used, for example.

Therefore, the image processing apparatus according to the present embodiment can convert an image indicated by an image signal to be processed into an image that has a larger number of pixels than that of an image processed based on the flow vector, by performing the process (the image process based on flow vectors) of (1) and the process (the enlargement process) of (2) while shortening the processing time and preventing degradation of image quality.

An example of a configuration of the image processing apparatus according to the present embodiment is explained below, and a detailed example of a process according to the image processing method according to the present embodiment is also explained.

### The Image Processing Apparatus According to the Present Embodiment

### [1] An Image Processing Apparatus According to a First Embodiment

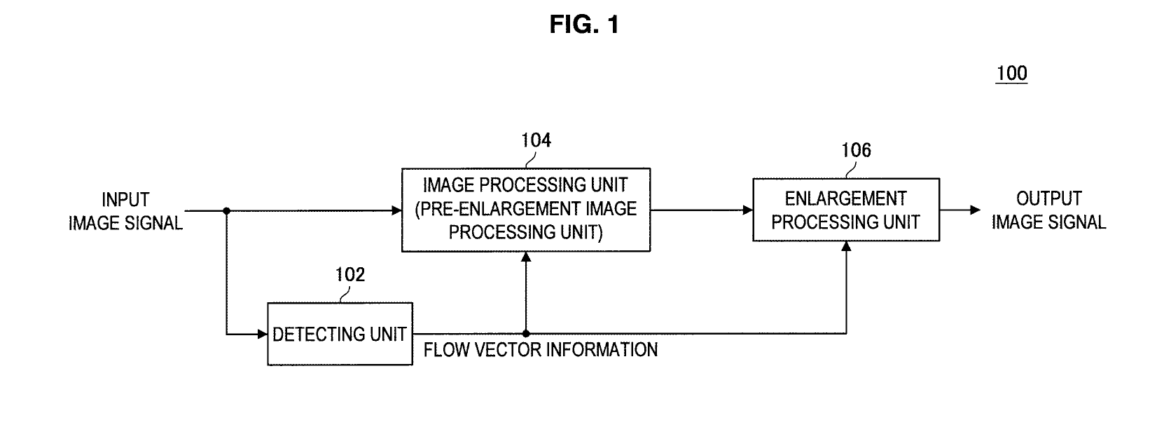

FIG. 1 is a block diagram showing an example of a configuration of an image processing apparatus 100 according to a first embodiment. The image processing apparatus 100 includes a detecting unit 102, an image processing unit 104 (a pre-enlargement image processing unit), and an enlargement processing unit 106.

The image processing apparatus 100 can be also arranged to include a control unit (not shown), a ROM (Read Only Memory, not shown), a RAM (Random Access Memory, not shown), a storage unit (not shown), an operating unit (not shown) that the user can operate, a display unit (not shown) that displays various screens on a display screen, and a communicating unit (not shown) that communicates with an external apparatus. The image processing apparatus 100 has constituent elements described above connected to each other by a bus as a data transmission path, for example.

The control unit (not shown) controls a whole of the image processing apparatus 100 that is constituted by an MPU (Micro Processing Unit) and various processing circuit. The control unit (not shown) can be also arranged to play a role of the detecting unit 102, the image processing unit 104, and the enlargement processing unit 106. The control unit (not shown) can be also arranged to play a role of performing a process to an image signal that is performed with a process according to an image processing method in the present embodiment, such as encoding an image signal (an output image signal) that is processed by the enlargement processing unit 106, recording the encoded image signal in the recording unit (not shown) and/or causing an image indicated by the image signal to be displayed on the display unit (not shown) or a display screen of an external display apparatus.

The ROM (not shown) stores control data such as a program and an arithmetic parameter that are used by the control unit (not shown). The RAM (not shown) temporarily stores a program and the like that is executed by the control unit (not shown).

The storage unit (not shown) is a storing function that is included in the image processing apparatus 100, and stores various data such as image data and applications, for example. The storage unit (not shown) includes a magnetic recording medium such as a hard disk, and a nonvolatile memory such as an EEPROM (Electrically Erasable and Programmable Read Only Memory) and a flash memory, for example. The storage unit (not shown) can be arranged to be detachable from the image processing apparatus 100.

The operating unit (not shown) includes a rotation-type selector such as a button, a direction key, and a jog dial, or a combination of these units. Further, the operating unit (not shown) may be an operation position detecting device, such as a touch pad, which is capable of detecting an operation position where an user touches. The image processing apparatus 100 can be also connected to an operation input device (for example, a keyboard and a mouse) as an external apparatus of the image processing apparatus 100, for example.

The display unit (not shown) includes a liquid crystal display (LCD), and an organic EL display (an organic ElectroLuminescence display, or also called an OLED display (an Organic Light Emitting Diode display)), for example. The display unit (not shown) can be also a device that can display and on which a user operation is possible, such as a touch screen, for example. The image processing apparatus 100 can be also connected to a display device (for example, an external display) as an external apparatus of the image processing apparatus 100, regardless of presence or absence of the display unit (not shown).

The communicating unit (not shown) is a communication function that is included in the image processing apparatus 100, and performs communications with an external apparatus by wireless/by wire via a network (or directly). The communicating unit (not shown) includes a communication antenna and an RF (Radio Frequency) circuit (a wireless communication), an IEEE802.15.1 port and a transmitting/receiving circuit (a wireless communication), an IEEE802.11b port and a transmitting/receiving circuit (a wireless communication), or a LAN (Local Area Network) terminal and a transmitting/receiving circuit (a wire communication), for example. The network according to the present embodiment includes a wire network such as a LAN and a WAN (Wide Area Network), a wireless network such as a wireless WAN (WWAN: Wireless Wide Area Network) via a base station, or the internet that uses a communication protocol such as TCP/IP (Transmission Control Protocol/Internet Protocol).

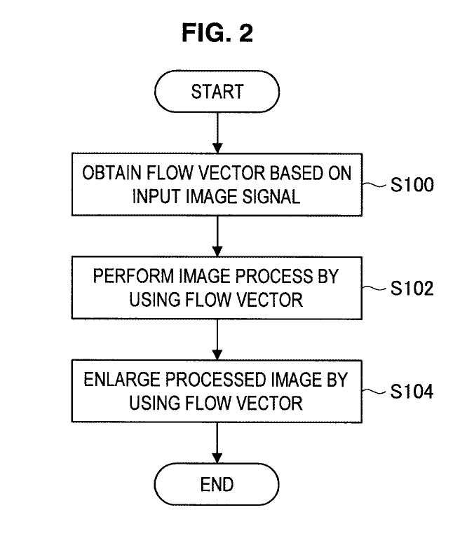

FIG. 2 is a flowchart showing an example of a process performed by the image processing apparatus 100 according to the first embodiment.

The image processing apparatus 100 obtains a set of flow vectors based on an input image signal (S100). In FIG. 1, the detecting unit 102 plays a role of performing the process of Step S100.

After the flow vectors are obtained at Step S100, the image processing apparatus 100 processes the input image signal by using the flow vectors (S102). The process of Step S102 corresponds to the process of (1) described above (the image process based on flow vectors). In FIG. 1, the image processing unit 104 plays a role of performing the process of Step S102.

After the process of Step S102 is performed, the image processing apparatus 100 enlarges the image indicated by the image signal processed at Step S102, by using the flow vectors obtained at Step S100 (S104). The process of Step S104 corresponds to the process (the enlargement process) of (2) described above. In FIG. 1, the enlargement processing unit 106 plays a role of processing the process of Step S104.

The image processing apparatus 100 according to the first embodiment realizes the image processing method according to the present embodiment by performing the process shown in FIG. 2, for example. A process performed by the image processing apparatus 100 according to the first embodiment is not limited to the process shown in FIG. 2. For example, when the flow vectors are set based on a user operation (for example, a trace operation) by using an operation position detecting device such as a touch pad or an operation input device such as a mouse, the image processing apparatus 100 is not necessary to perform the process of Step S100. In the above case, the image processing apparatus 100 performs the process of Step S102 and the process of Step S104 by using the flow vectors being set.

The image processing apparatus 100 can also perform the process of Step S102 and the process of Step S104 by obtaining flow vector information indicating a set of flow vectors corresponding to the input image signal, from an external apparatus such as a server, and by using the flow vectors indicated by the obtained flow vector information. For example, the image processing apparatus 100 obtains the information of the set of flow vectors corresponding to the input image signal from an external apparatus, by obtaining meta information contained in the input image signal from the input image signal, and by transmitting the obtained meta information to the external apparatus.

An example of a process (a process according to the image processing method) of the image processing apparatus 100 is explained below by explaining a configuration example of the image processing apparatus 100 according to the first embodiment shown in FIG. 1.

The detecting unit 102 detects a set of flow vectors corresponding to an input image, based on an input image signal. More specifically, the detecting unit 102 obtains a direction component (a flow vector) for each pixel of an image (hereinafter, also “input image”) indicated by the input image signal, based on the input image signal, for example. The detecting unit 102 outputs flow vector information that indicates the direction component for each obtained pixel.

[An Example of a Configuration of the Detecting Unit 102]

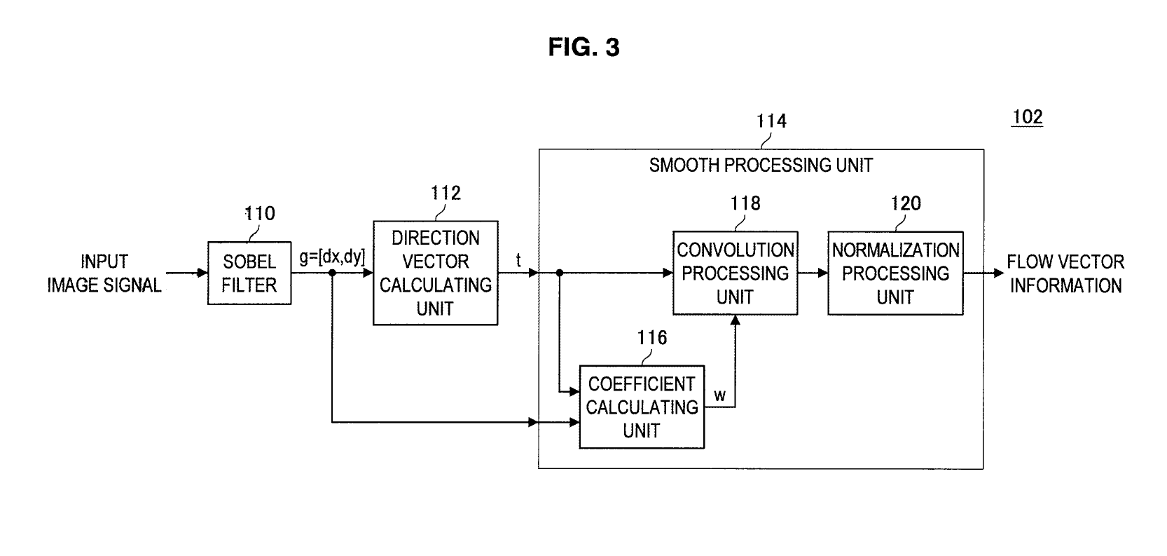

FIG. 3 is an explanatory diagram showing an example of a configuration of the detecting unit 102 that is included in the image processing apparatus 100 according to the first embodiment. The detecting unit 102 includes a Sobel filter 110, a direction vector calculating unit 112, and a smoothing processing unit 114.

The Sobel filter 110 is a filter that can check a gradient of brightness. The Sobel filter 110 multiplies a coefficient matrix T1 in a horizontal direction shown in Equation 1 and a coefficient matrix T2 in a vertical direction shown in Equation 2 respectively to a pixel value of 3×3 pixels centered around a focused pixel of the input image, for example. Then, the Sobel filter 110 outputs a value obtained by summing results of multiplication, as a brightness gradient vector g. In FIG. 3, a result of a process in the horizontal direction (a brightness gradient in the horizontal direction) is expressed as “dx”, and a result of a process in the vertical direction (a brightness gradient in the vertical direction) is expressed as “dy”.

$$\begin{matrix}T 1 = [ \begin{matrix}- 1 & 0 & 1 \\ - 2 & 0 & 2 \\ - 1 & 0 & 1\end{matrix} ] & Equation 1 \\ T 2 = [ \begin{matrix}- 1 & - 2 & - 1 \\ 0 & 0 & 0 \\ 1 & 2 & 1\end{matrix} ] & Equation 2\end{matrix}$$

In FIG. 3, although the detecting unit 102 is shown to have a configuration that includes the Sobel filter 110, a configuration of the detecting unit 102 is not limited to this configuration. For example, the detecting unit 102 according to the present embodiment can be arranged to include other filter such as a Prewitt filter instead of the Sobel filter 110.

The direction vector calculating unit 112 calculates a direction vector t for each pixel, based on the brightness gradient vector g that is transmitted from the Sobel filter 110. In this case, a direction vector t is a unit vector orthogonal to the brightness gradient vector g. That is, the direction vector t corresponds to a direction vector that expresses a direction in which the brightness gradient is smallest.

More specifically, the direction vector calculating unit 112 calculates the direction vector t by performing a calculation expressed by Equation 3 shown below, for example. A calculation method of the direction vector t of the direction vector calculating unit 112 is not limited to a method of calculation shown in Equation 3. For example, although an example that normalization is performed is expressed by Equation 3, the direction vector calculating unit 112 is not necessary to perform the normalization.

$$t = \frac{1}{\vert g \vert} \cdot ( [ \begin{matrix}0 & - 1 \\ 1 & 0\end{matrix} ] \cdot g ) \qquad Equation 3$$

The smoothing processing unit 114 includes a coefficient calculating unit 116, a convolution processing unit 118, and a normalization processing unit 120, for example, and outputs a flow vector of unit norm, based on the output value g that is transmitted from the Sobel filter 110 and the direction vector t that is transmitted from the direction vector calculating unit 112. The coefficient calculating unit 116 obtains a filter coefficient w at a pixel position. Although the coefficient calculating unit 116 calculates the filter coefficient w by using an “Edge Tangent Flow” algorithm that is described in the non-patent literature 1, for example, a calculation method is not limited to that described above. The convolution processing unit 118 smoothens the direction vector t based on the coefficient w obtained, and the normalization processing unit 120 normalizes a value that is smoothed by the convolution processing unit 118.

Based on the smoothing performed by the smoothing processing unit 114 as described above, the detecting unit 102 can obtain a more stable direction vector (a flow vector). By performing the process (the image process based on flow vectors) of (1) by using stable flow vectors, the direction of brush strokes to obtain a painterly image, for example, becomes stable. Therefore, it becomes possible to further improve a painterly image conversion process for converting an input image into a painterly image (when the image process is the painterly image conversion process for converting an image into a painterly image).

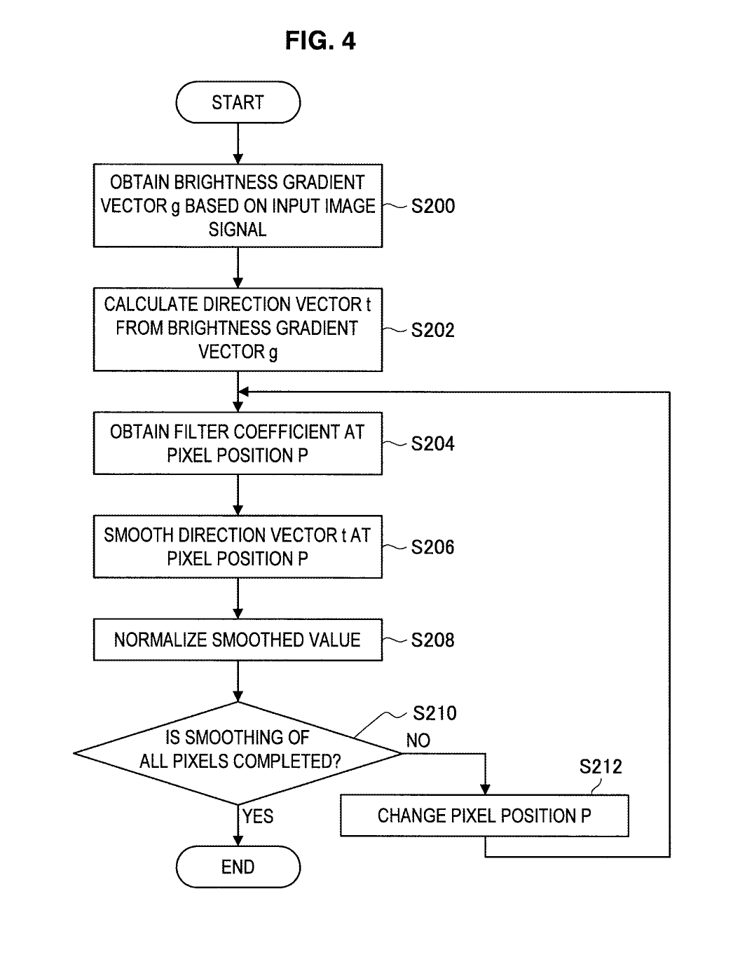

The detecting unit 102 according to the first embodiment detects a set of flow vectors corresponding to an input image based on an input image signal by the configuration shown in FIG. 3, for example. A series of processes of the detecting unit 102 shown in FIG. 3 are explained below with reference to FIG. 4. FIG. 4 is a flowchart showing an example of a process performed by the detecting unit 102 that is included in the image processing apparatus 100 according to the first embodiment.

The detecting unit 102 obtains the brightness gradient vector g based on the input image signal (S200). In FIG. 3, the Sobel filter 110 plays a role of performing the process of Step S200.

After the brightness gradient vector g is obtained at Step S200, the detecting unit 102 calculates the direction vector t from the brightness gradient vector g (S202). In FIG. 3, the direction vector calculating unit 112 plays a role of performing the process of Step S202.

After the direction vector t is calculated at Step S202, the detecting unit 102 obtains a filter coefficient at a pixel position P (S204). In FIG. 3, the coefficient calculating unit 116 plays a role of performing the process of Step S204. A pixel position P can be also expressed by coordinates having a position of a specific pixel as an origin.

After a filter coefficient at the pixel position P is obtained at Step S204, the detecting unit 102 smoothes the direction vector t at the pixel position P (S206). In FIG. 3, the convolution processing unit 118 plays a role of performing the process of Step S206.

After the direction vector t at the pixel position P is smoothed in Step S206, the detecting unit 102 normalizes the smoothed direction vector t (S208). In FIG. 3, the normalization processing unit 120 plays a role of performing the process of Step S208. Although the detecting unit 102 outputs a normalized direction vector t′ (a flow vector) at each time when the process of Step S208 is performed, for example, a process performed by the detecting unit 102 is not limited to that described above. For example, the detecting unit 102 can be arranged to output the normalized direction vector t′ (the flow vector) corresponding to each pixel position when it is determined that smoothing is completed at Step S210 described later.

After the smoothed direction vector t is normalized at Step S208, the detecting unit 102 determines whether smoothing of the direction vector t corresponding to all pixels corresponding to the input image is completed (S210). In FIG. 3, the smoothing unit 114 (for example, a process control circuit (not shown) included in the smoothing unit 114), for example, plays a role of performing the process of Step S210. The detecting unit 102 holds a process completion flag corresponding to each pixel position of all pixels, and updates a flag corresponding to the pixel position P to a completed state, each time when smoothing of the direction vector t at the pixel position P is completed, for example. The detecting unit 102 determines that smoothing of the direction vector t corresponding to all pixels corresponding to the input image is completed, when the process completion flag corresponding to all pixels indicates a completed state, for example. It is needless to mention that a determination method at Step S210 is not limited to that described above.

When it is not determined at Step S210 that smoothing of the direction vector t corresponding to all pixels is completed, the detecting unit 102 changes the pixel position P (S212), and repeats the process of Step S204 afterward.

When it is determined at Step S210 that smoothing of the direction vector t corresponding to all pixels is completed, the detecting unit 102 ends the process.

The detecting unit 102 detects a set of flow vectors corresponding to the input image based on the input image signal, by performing the process shown in FIG. 4 by the configuration shown in FIG. 3, for example.

A configuration of the detecting unit 102 according to the present embodiment is not limited to the configuration shown in FIG. 3, and a process performed by the detecting unit 102 is not limited to the process shown in FIG. 4. For example, the detecting unit 102 can be arranged to detect a flow vector (a representative value) for each predetermined region including plural pixels instead of each pixel. The detecting unit 102 can also be arranged to detect a flow vector for each pixel, by using the “Smoothed Structure Tensor” described in the non-patent literature 2, for example.

An example of a configuration of the image processing apparatus 100 according to the first embodiment is explained with reference to FIG. 1 again. The image processing unit 104 plays a role of mainly performing the process (the image process based on flow vectors) of (1), and processes the input image signal, based on a flow vector indicated by flow vector information transmitted from the detecting unit 102, for example.

As an image process that the image processing unit 104 performs based on a flow vector, there is a painterly image conversion process for converting the input image into a painterly image having brush strokes. More specifically, the image processing unit 104 specifies a pixel to be smoothed in the input image indicated by the input image signal based on a flow vector, and smoothes the input image, based on the specified pixel, for example. The image processing unit 104 converts the input image into a painterly image having brush strokes, by performing a filter process (a low-pass filter process, for example) along a direction component indicated by the flow vector, for example. However, a process performed by the image processing unit 104 is not limited to that described above. For example, the image processing unit 104 can be arranged to detect an outline part by performing a high-pass filter process to a direction going straight to a direction component indicated by the flow vector, lower a signal level of a pixel of the detected outline part, and convert the input image into a painterly image to which an outline is added.

An image process based on flow vectors of the image processing unit 104 according to the present embodiment is not limited to a painterly image conversion process. For example, the image processing unit 104 can be arranged to perform an arbitrary image process so far as the process is an image process that uses flow vectors such as a rendering process that uses flow vectors. An example of a configuration of the image processing unit 104 is explained below by taking an example that the image processing unit 104 performs a painterly image conversion process.

[An Example of a Configuration of the Image Processing Unit 104]

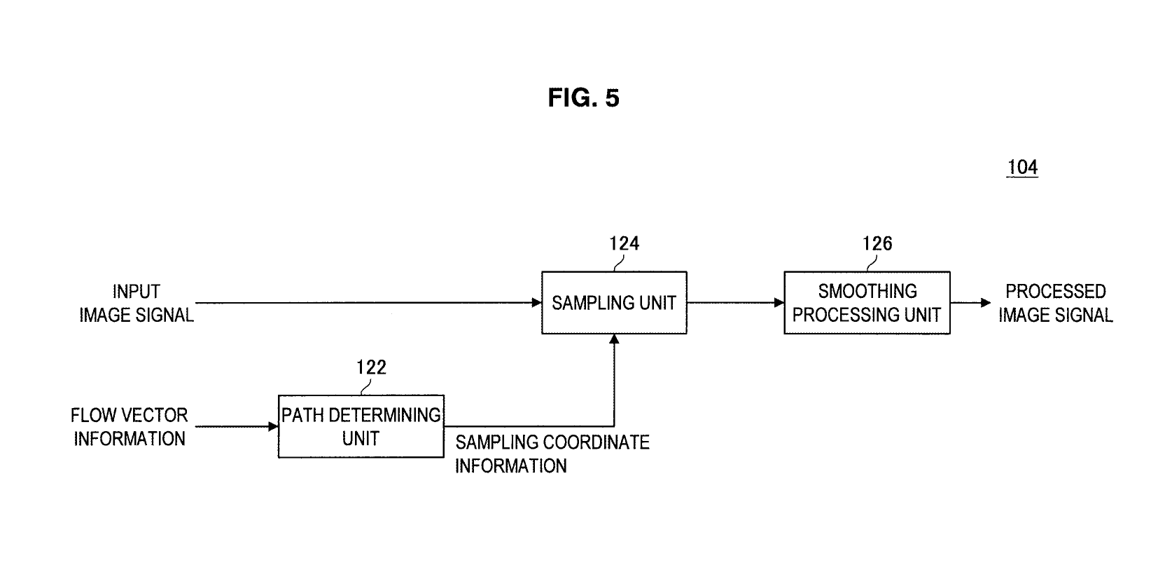

FIG. 5 is an explanatory diagram showing an example of a configuration of the image processing unit 104 that is included in the image processing apparatus 100 according to the first embodiment. The image processing unit 104 includes a path determining unit 122, a sampling unit 124, and a smoothing processing unit 126, for example. FIG. 5 shows an example of a configuration of a case where the “Line Integral Convolution” algorithm described in the non-patent literature 3 is used, for example.

The path determining unit 122 specifies a position of a pixel to be processed, based on flow vectors. More specifically, the path determining unit 122 performs a process of tracking back a focused pixel by a distance L to two directions along the flow vector corresponding to the focused pixel, to each focused pixel. That is, the process performed by the path determining unit 122 corresponds to a process of sampling a pixel to be processed. The path determining unit 122 transmits sampling coordinate information that indicates a position of the specified pixel by coordinates, to the sampling unit 124.

The sampling unit 124 extracts a pixel value of a pixel corresponding to coordinates indicated by the sampling coordinate information, from the input image, based on the sampling coordinate information transmitted from the path determining unit 122.

The smoothing processing unit 126 includes a filter such as a low-pass filter of (2×L+1) taps and a Gaussian filter, and smoothes a pixel value extracted by the sampling unit 124. The smoothing processing unit 126 outputs an image signal (an image signal that indicates an image after being processed; hereinafter, also “processed image signal”) that indicates an image obtained by smoothing the input image.

The smoothing processing unit 126 determines a filter coefficient of a filter that is included in the smoothing processing unit 126, by using a function or a table to which a pixel position and a filter coefficient are related in advance, for example. It is needless to mention that a method that the smoothing processing unit 126 according to the present embodiment uses to determine a filter coefficient is not limited to that described above.

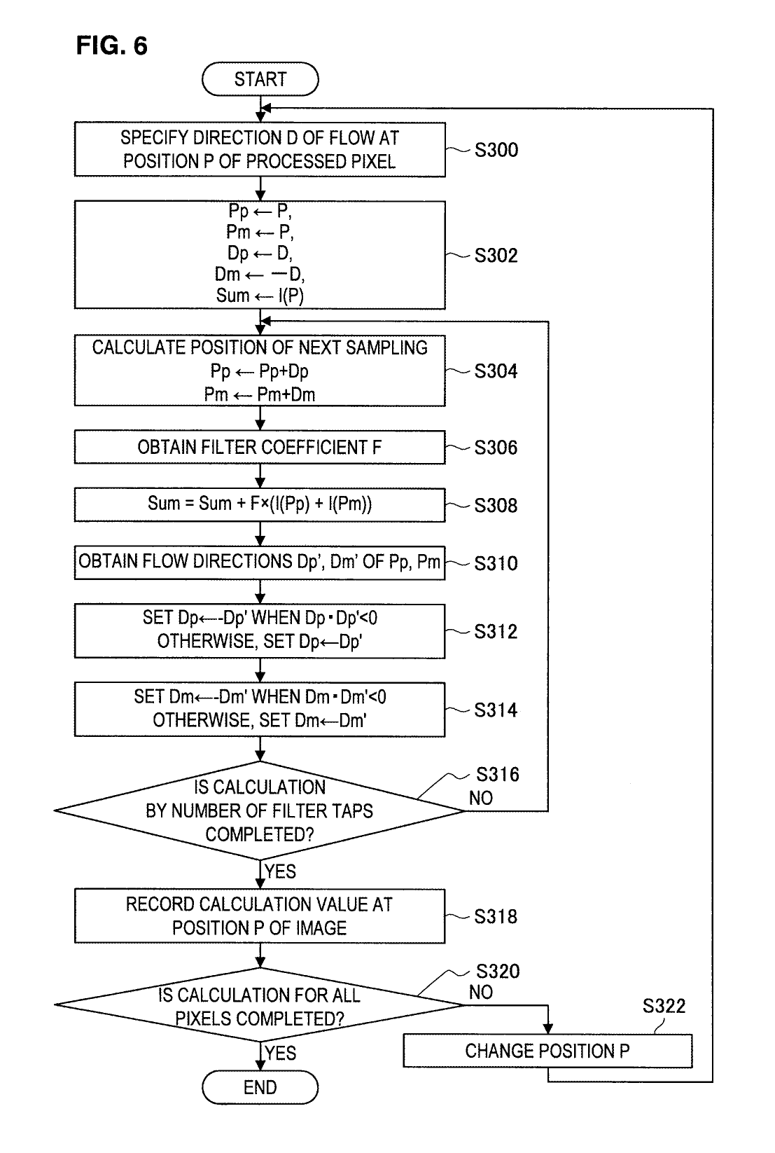

The image processing unit 104 according to the first embodiment processes an input image signal based on flow vectors, and converts the input image into a painterly image, by the configuration shown in FIG. 5, for example. A series of process performed by the image processing unit 104 shown in FIG. 5 are explained below with reference to FIG. 6. FIG. 6 is a flowchart showing an example of a process performed by the image processing unit 104 that is included in the image processing apparatus 100 according to the first embodiment.

The image processing unit 104 specifies a direction D of a flow at a position P of a processed pixel, by using a flow vector corresponding to a processed pixel (a focused pixel) (S300). The image processing unit 104 performs the process by using the position P that is expressed by the coordinates, for example.

After the direction D of the flow of the process pixel is specified at Step S300, the image processing unit 104 sets an initial value (S302). In this case, “Pp” indicates a position of a pixel in one direction prescribed by a flow vector, and “Pm” indicates a position of a pixel in other direction prescribed by the flow vector. “Dp” indicates a direction of the flow corresponding to Pp, and “Dm” indicates a direction of the flow corresponding to Pm. “I(P)” indicates a pixel value at the position P.

After the process of Step S302 is performed, the image processing unit 104 calculates the next sampling position (S304). After the next sampling position is calculated, the image processing unit 104 obtains a filter coefficient F corresponding to the next sampling position (S306). The image processing unit 104 determines the filter coefficient F by using a function or a table to which a pixel position and a filter coefficient are related in advance, for example.

After the filter coefficient is obtained at Step S306, the image processing unit 104 adds to “Sum”, values obtained by multiplying the filter coefficient F to a pixel value corresponding to the position Pp and to a pixel value corresponding to the position Pm (S308).

After a value of “Sum” is updated at Step S308, the image processing unit 104 obtains flow directions Dp′, Dm′ at the position Pp and the position Pm, based on corresponding flow vectors (S310).

After the flow directions Dp′, Dm′ are obtained at Step S310, the image processing unit 104 updates the flow direction Dp (S312), and updates the flow direction Dm (S314). At Steps S312 and S314, there is shown a process of the image processing unit 104 updating the flow directions Dp, Dm, corresponding to a value of an inner product of Dp and Dp′ and a value of an inner product of Dm and Dm′, for example. When the “Edge Tangent Flow” algorithm is used by the detecting unit 102, for example, it is not possible to determine the next sampling position by only the flow directions Dp′, Dm′ that are obtained at Step S310. Therefore, the image processing unit 104 aligns flows by performing the process shown at Steps S312 and S314, for example. It is needless to mention that a process relating to the alignment of flows is not limited to that at Steps S312 and S314. When the detecting unit 102 is not able to use the “Edge Tangent Flow” algorithm, for example, the image processing unit 104 can be arranged to update the flow direction Dp′ obtained at Step S310 to the flow direction Dp and update the flow direction Dm′ to the flow direction Dm, for example.

After the process of Steps S312 and S314 is performed, the image processing unit 104 determines whether a calculation corresponding to a number of taps of a filter is completed (S316). When it is not determined at Step S316 that the calculation by a number of taps of a filter is completed, the image processing unit 104 repeats the process of Step S304 afterward.

When it is determined at Step S316 that the calculation by a number of taps of a filter is completed, the image processing unit 104 records a calculation value (a value of Sum) at the position P of an output image (an image after the process) (S318).

After the process of Step S318 is performed, the image processing unit 104 determines whether a calculation of all pixels of the input image is completed (S320). When it is not determined at Step S320 that a calculation of all pixels of the input image is completed, the image processing unit 104 changes the position P of a focused pixel (S322), and repeats the process of Step S300 afterward. When it is determined at Step S320 that a calculation of all pixels of the input image is completed, the image processing unit 104 ends the process.

The image processing unit 104 processes the input image signal based on flow vectors, and converts the input image into a painterly image, by performing the process shown in FIG. 6 by the configuration shown in FIG. 5, for example.

A configuration of the image processing unit 104 according to the present embodiment is not limited to the configuration shown in FIG. 5, and a process performed by the image processing unit 104 is not limited to the process shown in FIG. 6. For example, the image processing unit 104 can be arranged to detect an outline part by performing a high-pass filter process to a direction going straight to a direction component indicated by the flow vector, lower a signal level of a pixel of the detected outline part, and convert the input image into a painterly image to which an outline is added. The image processing unit 104 can be arranged to perform an arbitrary image process so far as the process is an image process that uses flow vectors such as a rendering process that uses flow vectors, for example.

An example of a configuration of the image processing apparatus 100 according to the first embodiment is explained with reference to FIG. 1 again. The enlargement processing unit 106 plays a role of mainly performing the process (the enlargement process) of (2), and enlarges an image indicated by the image signal (the processed image signal) processed by the image processing unit 104, based on flow vectors indicated by flow vector information transmitted from the detecting unit 102, for example.

As described above, when a simple enlargement process is performed, there is a risk of occurrence of degradation of image quality such as blur in an image, for example. Therefore, the enlargement processing unit 106 interpolates an image indicated by the processed image signal that is transmitted from the image processing unit 104, corresponding to a direction component indicated by a flow vector indicated by the transmitted flow vector information, and converts the image into an image having a large number of pixels. More specifically, the enlargement processing unit 106 calculates for each position of an interpolated pixel, a flow vector that corresponds to the position of the interpolated pixel that is interpolated when performing the enlargement, based on the flow vector indicated by the transmitted flow vector information. The enlargement processing unit 106 obtains a pixel value of each interpolated pixel, based on the flow vector corresponding to each position of the calculated interpolated pixel and based on the processed image signal. By the process described above, it becomes possible to convert the image indicated by the processed image signal into the image having a larger number of pixels while preventing degradation of image quality.

[An Example of a Configuration of the Enlargement Processing Unit 106]

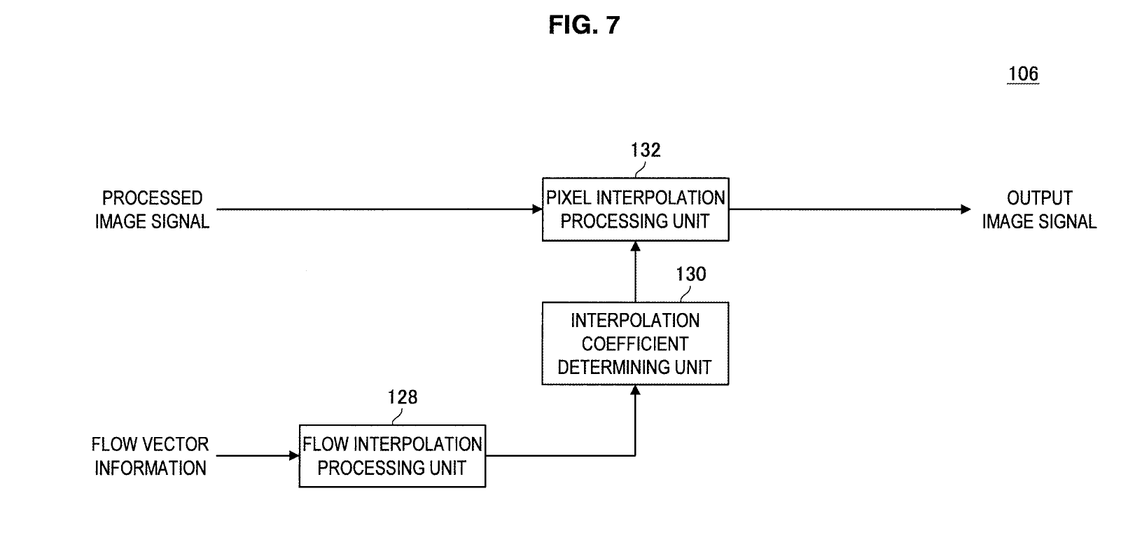

FIG. 7 is an explanatory diagram showing an example of a configuration of the enlargement processing unit 106 that is included in the image processing apparatus 100 according to the first embodiment. The enlargement processing unit 106 includes a flow interpolation processing unit 128, an interpolation coefficient determining unit 130, and a pixel interpolation processing unit 132.

The flow interpolation processing unit 128 obtains a flow vector at a position of a pixel to be interpolated (hereinafter, also “interpolated pixel”), by using flow vectors indicated by the flow vector information transmitted from the detecting unit 102. That is, the flow interpolation processing unit 128 interpolates the flow vector corresponding to the interpolated pixel, by using the flow vectors transmitted from the detecting unit 102. The flow interpolation processing unit 128 transmits to the interpolation coefficient determining unit 130, information that indicates a phase of the interpolated pixel and information (hereinafter, also “interpolated flow-vector information”) that indicates a flow vector corresponding to each pixel transmitted from the detecting unit 102 and a flow vector corresponding to the interpolated pixel, for example.

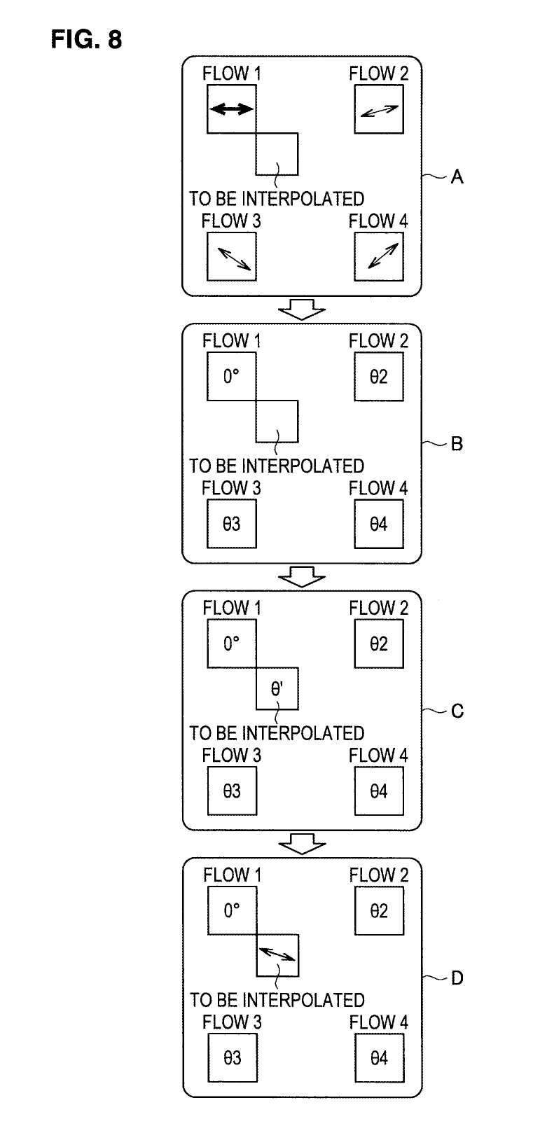

FIGS. 8A to 8D are explanatory diagrams showing an example of an interpolation process of a flow vector performed by the enlargement processing unit 106 that is included in the image processing apparatus 100 according to the first embodiment. An interpolation process of flow vectors that the flow interpolation processing unit 128 of the enlargement processing unit 106 performs is explained with reference to FIGS. 8A to 8D.

The flow interpolation processing unit 128 obtains a flow vector that corresponds to a nearest pixel of the interpolated pixel (shown in FIG. 8A). FIGS. 8A to 8D show an example of obtaining a flow 1.

Further, the flow interpolation processing unit 128 obtains flow vectors at a periphery of the interpolated pixel (a flow 2, a flow 3, and a flow 4, in the example of FIGS. 8A to 8D, for example), and calculates an angle difference θ(θ<180 [°]) between the nearest flow vector and each peripheral flow vector (FIG. 8B). In this case, the flow interpolation processing unit 128 sets 0 [°] as the angle difference of the pixel corresponding to the nearest flow vector.

The flow interpolation processing unit 128 calculates an angle difference θ′ of the interpolated pixel, by performing a bilinear interpolation process by using the calculated angle difference (FIG. 8C). The flow interpolation processing unit 128 sets a vector obtained as a result of adding the angle difference θ′ to the angle difference between the flow vector corresponding to the nearest pixel and a reference direction (a horizontal direction, for example), as a flow vector corresponding to the interpolated pixel (FIG. 8D).

The flow interpolation processing unit 128 interpolates the flow vector corresponding to the interpolated pixel, by performing the process described above with reference to FIGS. 8A to 8D, for example. An interpolation process of a flow vector performed by the flow interpolation processing unit 128 according to the present embodiment is not limited to that described above. For example, the flow interpolation processing unit 128 can be arranged to use a flow vector corresponding to the nearest pixel, as the flow vector corresponding to the interpolated pixel. As described above, the flow interpolation processing unit 128 can reduce a processing quantity, by using the flow vector corresponding to the nearest pixel, as the flow vector corresponding to the interpolated pixel.

An example of a configuration of the enlargement processing unit 106 is explained with reference to FIG. 7 again. The interpolation coefficient determining unit 130 determines the filter coefficient W (hereinafter, also “interpolation coefficient W”) that is used to interpolate pixels, based on a phase of an interpolated pixel and a direction indicated by the flow vector corresponding to the interpolated pixel.

The interpolation coefficient determining unit 130 uniquely determines the filter coefficient W, by referring to a combination of a phase and a flow vector, and a table to which the filter coefficient is related, for example. The table is stored in a ROM (not shown) and the like that is included in the image processing apparatus 100, for example, and the interpolation coefficient determining unit 130 determines the filter coefficient W by referring to the ROM (not shown) and the like. The interpolation coefficient determining unit 130 can be arranged to hold the table by reading the table before performing a process, or suitably refer to the ROM (not shown) and the like. A process performed by the interpolation coefficient determining unit 130 is not limited to that described above. For example, the interpolation coefficient determining unit 130 can be arranged to communicate with an external apparatus such as a server that stores the table, via a communicating unit (not shown), and obtain the filter coefficient W that corresponds to the phase of the interpolated pixel and the interpolated pixel from the external apparatus.

The filter coefficient W according to the present embodiment includes an interpolation coefficient that has a characteristic of suppressing blur in a direction orthogonal with the flow and strongly smoothening in a parallel direction. By using a specific filter coefficient W as described above, the pixel interpolation processing unit 132 described later can obtain an interpolated result which is smooth and has little blur. Further, by using the specific filter coefficient W for strongly smoothing in a parallel direction, jaggy can be reduced, even when the jaggy is present in an image indicated by a processed image signal, for example. When the image processing unit 104 performs a painterly image conversion process, there is a possibility that undesirable jaggy occurs near an edge. Even when jaggy occurs as described above, the pixel interpolation processing unit 132 can reduce the jaggy by using the specific filter coefficient W by strongly smoothing in a parallel direction. Therefore, a higher image quality can be realized.

The pixel interpolation processing unit 132 obtains a pixel value of an interpolated pixel, by sampling pixel values of a peripheral pixels of the interpolated pixel, and by performing a convolution process by using the filter coefficient W determined by the interpolation coefficient determining unit 130.

The pixel interpolation processing unit 132 outputs an image signal (hereinafter, also “output image signal”) that indicates an image of which a number of pixels is improved by interpolation. The output image signal is encoded by a control unit (not shown), is stored in a storage unit (not shown) and the like, and/or an image indicated by the output image signal is displayed on a display screen of a display unit (not shown) or an external display apparatus, for example.

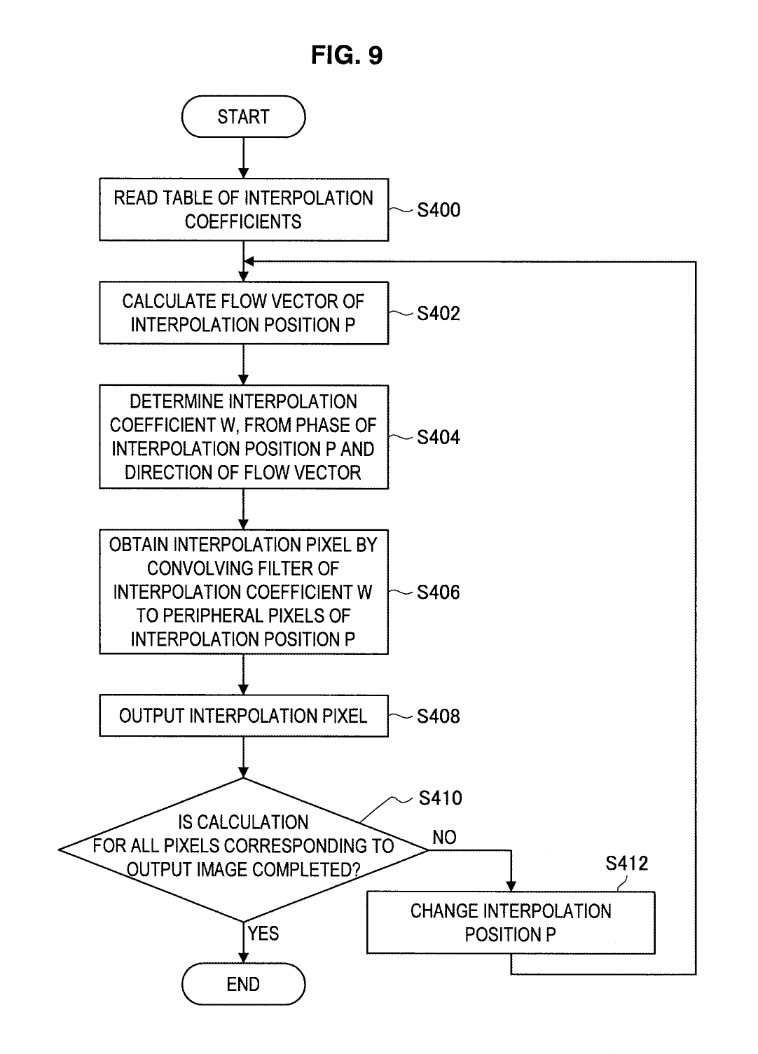

The enlargement processing unit 106 according to the first embodiment enlarges an image indicated by the processed image signal that is processed by the image processing unit 104, based on flow vectors by the configuration shown in FIG. 7, for example. A series of process performed by the enlargement processing unit 106 shown in FIG. 7 is explained below with reference to FIG. 9. FIG. 9 is a flowchart showing an example of a process performed by the enlargement processing unit 106 that is included in the image processing apparatus 100 according to the first embodiment.

The enlargement processing unit 106 reads a table of interpolation coefficients (a table in which a combination of a phase and a flow vector is related to a filter coefficient, for example) (S400). When the enlargement processing unit 106 is configured to suitably refer to the table of interpolation coefficients, the enlargement processing unit 106 is not necessary to perform the process of Step S400.

The enlargement processing unit 106 calculates a flow vector corresponding to an interpolation position P as a position of the interpolated pixel (S402). The enlargement processing unit 106 calculates a flow vector corresponding to the interpolation position P, by performing the process shown in FIGS. 8A to 8D, for example.

After a flow vector corresponding to the interpolation position P is calculated at Step S402, the enlargement processing unit 106 determines the interpolation coefficient W, based on a phase of the interpolation position P and a direction of the flow vector (S404). The enlargement processing unit 106 determines the interpolation coefficient W, by using the table that is read at Step S400, for example.

After the interpolation coefficient W is determined at Step S404, the enlargement processing unit 106 obtains a pixel value of the interpolated pixel, by convolving a filter that uses the interpolation coefficient W as a filter coefficient, to peripheral pixels of the interpolation position P (S406). The enlargement processing unit 106 outputs the interpolated pixel (S408). When the enlargement processing unit 106 determines at Step S410 described later that a calculation of all pixels corresponding to the image (hereinafter, also “output image”) corresponding to the output image signal is completed, for example, the enlargement processing unit 106 can be arranged to output each interpolated pixel and each pixel corresponding to the processed image signal.

After the process of Steps S406 and S408 is performed, the enlargement processing unit 106 determines whether a calculation of all pixels corresponding to the output image is completed (S410). When it is not determined at Step S410 that a calculation of all pixels corresponding to the output image is completed, the enlargement processing unit 106 changes the interpolation position P (S412), and repeats the process of Step S402 afterward. When it is determined at Step S410 that a calculation of all pixels corresponding to the output image is completed, the enlargement processing unit 106 ends the process.

The enlargement processing unit 106 enlarges the image indicated by the processed image signal that is processed by the image processing unit 104, based on the flow vectors, by performing the process shown in FIG. 9 by the configuration shown in FIG. 7, for example. It is needless to mention that a configuration of the enlargement processing unit 106 according to the present embodiment is not limited to the configuration shown in FIG. 7 and that a process performed by the enlargement processing unit 106 is not limited to the process shown in FIG. 9.

The image processing apparatus 100 according to the first embodiment converts an image indicated by an image signal to be processed into an image that has a larger number of pixels than that of an image processed based on a flow vector, by performing the process (the image process based on flow vectors) of (1) and the process (the enlargement process) of (2) according to the image processing method according to the present embodiment, by the configuration shown in FIG. 1, for example.

Because the image processing apparatus 100 shown in FIG. 1 performs the painterly image conversion process (an example of the image process according to the present embodiment) and the interpolation process (the enlargement process), by using a single set of flow vectors, it is possible to save a processing time that is necessary to calculate the direction component. By using a common flow vector, a direction characteristic of a filter that is used in the painterly image conversation process and a direction characteristic of a filter that is used in the interpolation process are arranged. Because the image processing apparatus 100 can perform a process by obtaining a direction component that is desirable in the interpolation process, degradation of image quality due to an interpolation by an inappropriate direction component can be prevented.

Therefore, the image processing apparatus according to the first embodiment can convert an image indicated by an image signal to be processed into an image that has a larger number of pixels than that of an image processed based on flow vectors, while shortening a processing time and preventing degradation of image quality.

### A Modification of a Configuration of the Image Processing Apparatus 100 According to the First Embodiment

A configuration of the image processing apparatus 100 according to the first embodiment is not limited to the configuration shown in FIG. 1. For example, although FIG. 1 shows the configuration that the image processing apparatus 100 includes the detecting unit 102 and performs the process by using the flow vectors that the detecting unit 102 detects from the input image signal, the image processing apparatus 100 according to the first embodiment is not necessary to include the detecting unit 102. For example, when the flow vectors are set based on an operation of a user who uses an operation position detecting device such as a touch pad and an operation input device such as a mouse, the image processing apparatus 100 can be arranged to perform the process by using flow vectors that are set based on a user operation transmitted from the operation position detecting device and the like. Even when the process is performed by using the flow vectors that are set based on the user operation as described above, the image processing apparatus 100 according to the first embodiment has an advantage that is similar to that obtained by the image processing apparatus 100 shown in FIG. 1.

When a flow vector is set based on a user operation, a value of one or more flow vectors is given based on the user operation. This value of vectors is to be set, as a set of flow vectors of the same value, for plural pixels which correspond to a position traced according to the user operation.

Further, respective values of flow vectors may be set at each position which corresponds to the position traced according to the user operation (trajectory of user operation).

The image processing apparatus 100 according to the first embodiment can be arranged to obtain flow vector information indicating a set of flow vectors corresponding to the image indicated by the input image signal, from an external apparatus such as a server, and perform the process by using the flow vector indicated by the obtained flow vector information. For example, the image processing apparatus 100 obtains the flow vector information corresponding to the image indicated by the input image signal from the external apparatus, by obtaining meta information contained in the input image signal from the input image signal and by transmitting the obtained meta information to the external apparatus. As described above, even when the process is performed by using the flow vectors corresponding to the image indicated by the input image signal that is indicated by the flow vector information obtained from the external apparatus, the image processing apparatus 100 according to the first embodiment has the advantage similar to that obtained by the image processing apparatus 100 shown in FIG. 1.

The image processing apparatus 100 according to the first embodiment can be arranged to further include an image pickup unit (not shown) that picks up an image of a moving image, in addition to the configuration shown in FIG. 1, for example. When a configuration described above is included, the image processing apparatus 100 can process the input image signal that is generated by the image picked up by the image pickup unit (not shown), for example.

The image pickup unit (not shown) according to the present embodiment includes an image pickup device that is configured by a lens/an image pickup element and a signal processing circuit, for example. The lens/the image pickup element are configured by a lens of an optical system, and an image sensor that uses plural image pickup elements such as a CCD (Charge Coupled Device) or a CMOS, (Complementary Metal Oxide Semiconductor),or the like, for example. The image processing circuit includes an AGC (Automatic Gain Control) circuit and an ADC (Analog to Digital Converter), converts an analog signal generated by the image pickup element into a digital signal (image data), and performs various kinds of signal processing. A signal processing that is performed by the signal processing circuit includes a white balance correction process, a chrominance correction process, a gamma correction process, a YCbCr conversion process, an edge emphasis process, etc.

### [2] An Image Processing Apparatus According to a Second Embodiment

A configuration of an image processing apparatus according to the present embodiment is not limited to the configuration of the image processing apparatus 100 according to the first embodiment described above. For example, the image processing apparatus according to the present embodiment can be arranged to perform plural image processes such as plural painterly image conversion processes in a sequence. An example of a configuration of an image processing apparatus 200 according to the second embodiment that corresponds to a case of performing plural image processes is explained next.

When plural painterly image conversion processes are performed in a sequence, image sizes that are optimum for these processes are sometimes different. When image sizes that are optimum for processes are different as described above, the process (the enlargement process) of (2) is performed to convert an image size to a suitable image size, and thereafter, a painterly image conversion process is performed to each image. However, in case of further performing a painterly image conversion process to an output image signal that is output from the enlargement processing unit 106 of the image processing apparatus 100 shown in FIG. 1, for example, it is necessary to detect again a flow vector corresponding to each pixel corresponding to an enlarged image. Therefore, there is a risk of increasing the processing time.

The image processing apparatus 200 according to the second embodiment sets flow vectors (flow vectors indicated by interpolated flow-vector information that is output from the flow interpolation processing unit 128, for example) that is obtained by re-sampling the flow vectors by interpolation at the time of performing the process (the enlargement process) of (2), as a set of flow vectors corresponding to the enlarged image.

As explained with reference to FIG. 7, the enlargement processing unit 106 that plays a role of performing the process (the enlargement process) of (2) enlarges the image to be processed, by calculating a flow vector corresponding to an interpolated pixel, and by interpolating the interpolated pixel, for example. That is, in the image processing apparatus according to the present embodiment, the flow vectors re-sampled by interpolation at the time of performing the process (the enlargement process) of (2) corresponds to the enlarged image. Therefore, when the image processing apparatus 200 according to the second embodiment processes the enlarged image by using the flow vector corresponding to the enlarged image that is already calculated, the image processing apparatus 200 is not necessary to detect again the flow vector that corresponds to each pixel corresponding to the enlarged image.

Therefore, the image processing apparatus 200 according to the second embodiment can process plural images while shortening a processing time. An example of a configuration of the image processing apparatus 200 according to the second embodiment is explained next.

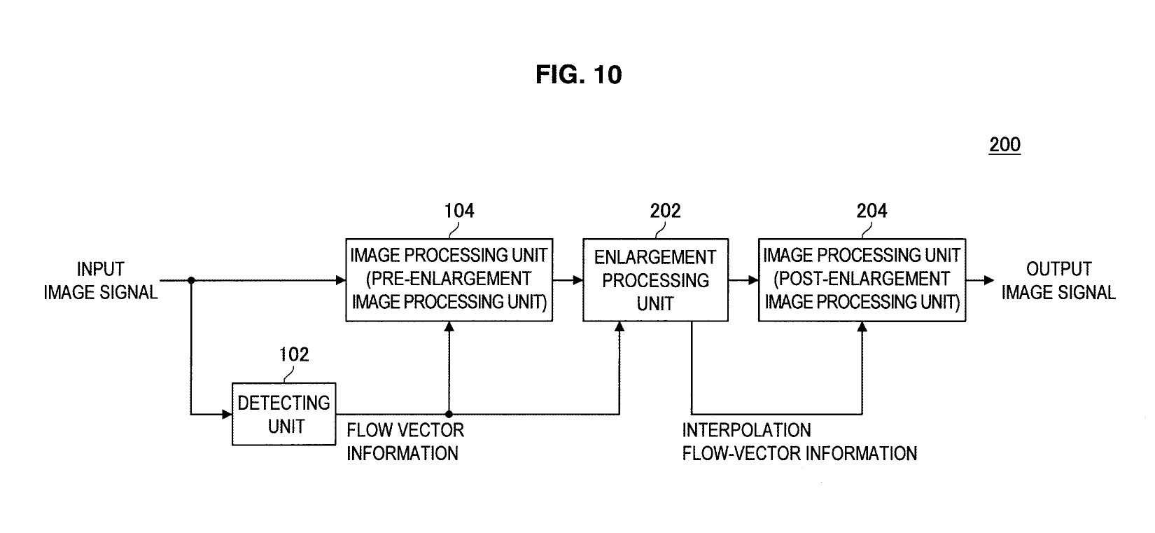

FIG. 10 is a block diagram showing an example of a configuration of the image processing apparatus 200 according to the second embodiment. The image processing apparatus 200 includes the detecting unit 102, the image processing unit 104 (the pre- enlargement image processing unit), an enlargement processing unit 202, and an image processing unit 204

The image processing apparatus 200 according to the second embodiment shown in FIG. 10 basically has a configuration similar to that of the image processing apparatus 100 according to the first embodiment shown in FIG. 1. However, the image processing apparatus 200 according to the second embodiment further includes the image processing unit 204, as compared with the image processing apparatus 100 according to the first embodiment shown in FIG. 1. Further, in the image processing apparatus 200 according to the second embodiment, a function of the enlargement processing unit 202 is different from that of the enlargement processing unit 106 according to the first embodiment.

Although the enlargement processing unit 202 has a configuration and a function that are basically similar to those of the enlargement processing unit 106 according to the first embodiment, the enlargement processing unit 202 is different from the enlargement processing unit 106 according to the first embodiment in that the enlargement processing unit 202 transmits interpolated flow-vector information to the image processing unit 204.

[An Example of a Configuration of the Enlargement Processing Unit 202]

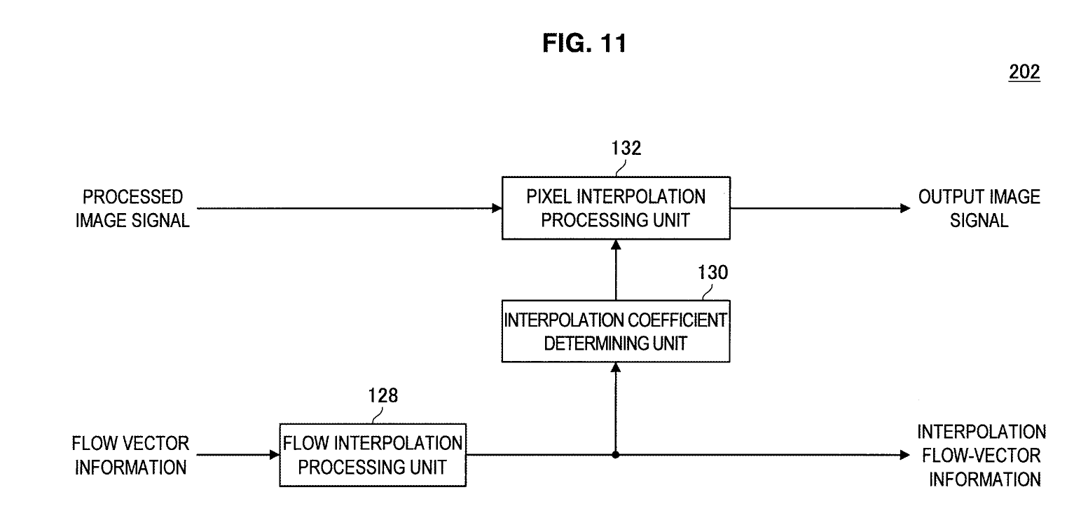

FIG. 11 is an explanatory diagram showing an example of a configuration of the enlargement processing unit 202 that is included in the image processing apparatus 200 according to the second embodiment. As shown in FIG. 11, the enlargement processing unit 202 includes a flow interpolation processing unit 128 that has functions and configurations similar to those of the enlargement processing unit 106, the interpolation coefficient determining unit 130, and the pixel interpolation processing unit 132 shown in FIG. 7, for example. In comparing between FIG. 11 and FIG. 7, the enlargement processing unit 202 is different from the enlargement processing unit 106 according to the first embodiment in that the interpolated flow-vector information that is output from the flow interpolation processing unit 128 is output to an outside of the enlargement processing unit 202.

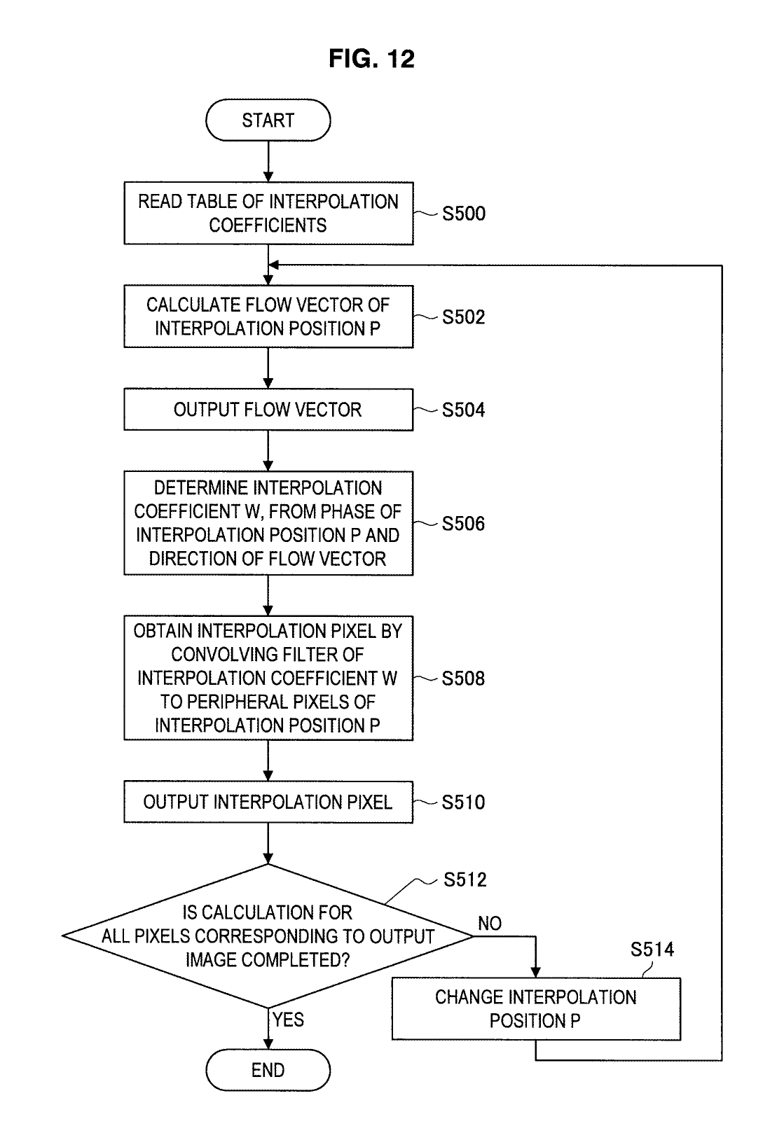

FIG. 12 is a flowchart showing an example of a process performed by the enlargement processing unit 202 that is included in the image processing apparatus 200 according to the second embodiment.

The enlargement processing unit 202 reads a table of interpolation coefficients (a table in which a combination of a phase and a flow vector is related to a filter coefficient, for example) (S500), in a similar manner to that at Step S400 shown in FIG. 9. When the enlargement processing unit 202 is configured to suitably refer to the table of interpolation coefficients, the enlargement processing unit 202 is not necessary to perform the process of Step S500.

The enlargement processing unit 202 calculates a flow vector corresponding to the interpolation position P as a position of the interpolated pixel (S502), in a similar manner to that at Step S402 shown in FIG. 9. The enlargement processing unit 202 outputs a flow vector that corresponds to the calculated interpolation position P (S504). When it is determined at Step S512 to be described later that a calculation of all pixels corresponding to the output image is completed, for example, the enlargement processing unit 202 can be arranged to output a flow vector indicated by the flow vector information that is transmitted from the detecting unit 102 and a flow vector that corresponds to each interpolated pixel. It is not necessary to perform the process of Step S504 when an image process such as a painterly image process and other enlargement process are not performed at a latter stage of the enlargement processing unit 202.

After the flow vector corresponding to the interpolation position P is calculated at Step S502, the enlargement processing unit 202 determines the interpolation coefficient W, based on a phase of the interpolation position P and a direction of the flow vector (S506), in a similar manner to that at Step S404 shown in FIG. 9.

After the interpolation coefficient W is determined at Step S506, the enlargement processing unit 202 obtains a pixel value of the interpolated pixel, by convolving a filter that uses the interpolation coefficient W as a filter coefficient, to peripheral pixels of the interpolation position P (S508), in a similar manner to that at Step S406 shown in FIG. 9. The enlargement processing unit 202 outputs the interpolated pixel (S510). When the enlargement processing unit 202 determines at Step S512 described later that a calculation of all pixels corresponding to the output image is completed, for example, the enlargement processing unit 202 can be arranged to output each interpolated pixel and each pixel corresponding to the processed image signal.

After the process of Steps S508 and S510 is performed, the enlargement processing unit 202 determines whether a calculation of all pixels corresponding to the output image is completed (S512). When it is not determined at Step S512 that a calculation of all pixels corresponding to the output image is completed, the enlargement processing unit 202 changes the interpolation position P (S514), and repeats the process of Step S502 afterward. When it is determined at Step S512 that a calculation of all pixels corresponding to the output image is completed, the enlargement processing unit 202 ends the process.

The enlargement processing unit 202 enlarges the image indicated by the processed image signal that is processed by the image processing unit 104, based on the flow vectors by performing the process shown in FIG. 12 by the configuration shown in FIG. 11, for example. It is needless to mention that a configuration of the enlargement processing unit 202 according to the present embodiment is not limited to the configuration shown in FIG. 11 and that a process performed by the enlargement processing unit 202 is not limited to the process shown in FIG. 12.

A configuration of the image processing apparatus 200 according to the second embodiment is explained with reference to FIG. 10 again. The image processing unit 204 processes the image signal that indicates an enlarged image transmitted from the enlargement processing unit 202, based on interpolated flow-vector information (information that indicates a set of flow vectors corresponding to an input image and a flow vector corresponding to each position of an interpolated pixel) that is transmitted from the enlargement processing unit 202.

As an image process that the image processing unit 204 performs based on flow vectors, there is a painterly image conversion process, but the image process that the image processing unit 204 performs based on flow vectors is not limited to the painterly image conversion process. For example, the image processing unit 204 can be arranged to perform an arbitrary image process so far as the image process uses flow vectors such as a rendering process that uses the flow vectors.

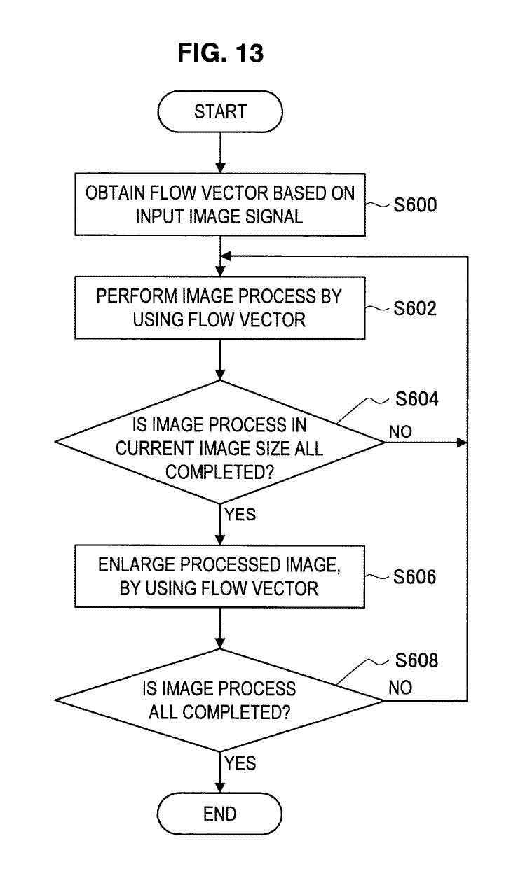

The image processing apparatus 200 according to the second embodiment performs plural image processes, by the configuration shown in FIG. 10, for example. A series of process performed by the image processing apparatus 200 shown in FIG. 10 are explained below with reference to FIG. 13. FIG. 13 is a flowchart showing an example of a process performed by the image processing apparatus 200 according to the second embodiment.

The image processing apparatus 200 obtains flow vectors based on an input image signal (S600), in a similar manner to that at Step S100 shown in FIG. 2.

After the flow vectors are obtained at Step S600, the image processing apparatus 200 processes the input image signal by using the flow vectors (S602), in a similar manner to that at Step S102 shown in FIG. 2.

After the process of Step S602 is performed, the image processing apparatus 200 determines whether the image process of a current image size is all completed (S604). When a process of all pixels corresponding to the input image is completed, for example, the image processing apparatus 200 determines that the image process of a current image size is all completed.

When it is not determined at Step S604 that the image process of a current image size is all completed, the image processing apparatus 200 repeats the process of Step S602 afterward.

When it is determined at Step S604 that the image process of a current image size is all completed, the image processing apparatus 200 enlarges an image indicated by the image signal processed at Step S602, by using the flow vectors obtained at Step S600 (S606), in a similar manner to that at Step S104 shown in FIG. 2.

After the process of Step S606 is performed, the image processing apparatus 200 determines whether the image process based on all flow vectors is completed (S608). When it is not determined at Step S608 that the image process based on all flow vectors is completed, the image processing apparatus 200 repeats the process of Step S602 afterward. In performing the process of Step S602 again, the image processing apparatus 200 uses a set of flow vectors corresponding to the enlarged image. When it is determined at Step S608 that the image process based on all flow vectors is completed, the image processing apparatus 200 ends the process.

The image processing apparatus 200 according to the second embodiment realizes the image processing method according to the present embodiment, by performing the process shown in FIG. 13, for example. A process performed by the image processing apparatus 200 according to the second embodiment is not limited to the process shown in FIG. 13. For example, when the flow vector is set based on a user operation, the image processing apparatus 200 is not necessary to perform the process of Step S600. In the above case, the image processing apparatus 200 performs the process of Step S602 afterward by using the flow vectors being set. The image processing apparatus 200 can also perform the process of Step S602 afterward by using a set of flow vectors indicated by flow vector information obtained from an external apparatus such as a server.

The image processing apparatus 200 according to the second embodiment has a configuration as shown in FIG. 10 which is similar to the configuration of the image processing apparatus 100 according to the first embodiment, for example. Therefore, the image processing apparatus 200 can convert an image indicated by an image signal to be processed into an image that has a larger number of pixels than that of an image processed based on a set of flow vectors, by performing the process (the image process based on flow vectors) of (1) and the process (the enlargement process) of (2) according to the image processing method according to the present embodiment.

The image processing apparatus 200 sets a set of flow vectors obtained by re-sampling flow vectors by interpolation at the time of performing the process (the enlargement process) of (2) by the enlargement processing unit 202, as a set of flow vectors corresponding to the enlarged image. Therefore, the image processing apparatus 200 can obtain the flow vectors corresponding to the enlarged image without performing detection process again, and can use the flow vectors corresponding to the enlarged image for a subsequent image process.

Therefore, the image processing apparatus 200 according to the second embodiment can perform plural image processes while shortening a processing time.

### A Modification of a Configuration of the Image Processing Apparatus 200 According to the Second Embodiment

A configuration of the image processing apparatus 200 according to the second embodiment is not limited to the configuration shown in FIG. 10. For example, although FIG. 10 shows the configuration that one image processing unit (the image processing unit 204) is included at a latter stage of the enlargement processing unit 202, the image processing apparatus 200 according to the second embodiment can also include plural image processing units at a latter stage of the enlargement processing unit 202. Based on the configuration described above, each image processing unit provided at the latter stage of the enlargement processing unit 202 can also perform a process by using the flow vectors re-sampled by interpolation by the enlargement processing unit 202, as a set of flow vectors corresponding to the enlarged image. Therefore, based on the configuration described above, the image processing apparatus 200 according to the second embodiment also has an advantage similar to that obtained by the image processing apparatus 200 shown in FIG. 10.

The image processing apparatus 200 according to the second embodiment can be arranged to further include other enlargement processing unit that performs the process (the enlargement process) of (2), in addition to the plural image processing unit at the latter stage of the enlargement processing unit 202. In the configuration described above, the image processing unit that is included at the latter stage of other enlargement processing unit can perform the process by using the flow vectors re-sampled by interpolation by the other enlargement processing unit, as a set of flow vectors corresponding to the enlarged image. Therefore, when the configuration described above is employed, the image processing apparatus 200 according to the second embodiment can perform an image process (a painterly image conversion process, for example) based on an arbitrary number of flow vectors, in an arbitrary number of processing resolution.

Further, the image processing apparatus 200 according to the second embodiment can take a modification similar to that of the image processing apparatus 100 according to the first embodiment described above.

### An Image Processing Apparatus According to a Third Embodiment

A configuration of an image processing apparatus according to the present embodiment is not limited to the configurations of the image processing apparatus 100 according to the first embodiment and the image processing apparatus 200 according to the second embodiment described above. An example of a configuration of an image processing apparatus 300 according to the third embodiment is explained next.

In case of performing the process (the image process based on flow vectors) of (1), when a rendering process (an example of an image process that does not correspond to flow vectors) based on a user operation is performed, for example, there is a risk that the processed image does not correspond to the flow vectors. There is a possibility that the risk that the processed image does not correspond to the flow vectors also occurs when an excessive process such as brush stroke patterns being deflected from a processed region, has been performed during a painterly image conversion process by rendering brush stroke patterns. When the processed image does not correspond to the flow vectors, there is a possibility that undesirable interpolation is performed for the interpolated pixels in the process (the enlargement process) of (2) and that image quality is degraded as a result.

The image processing apparatus 300 according to the third embodiment prevents degradation of the image quality, by relating the processed image to the flow vectors, by updating the flow vectors, corresponding to a result of performing the process (the image process based on flow vectors) of (1). An example of a configuration of the image processing apparatus 300 according to the third embodiment is explained next.

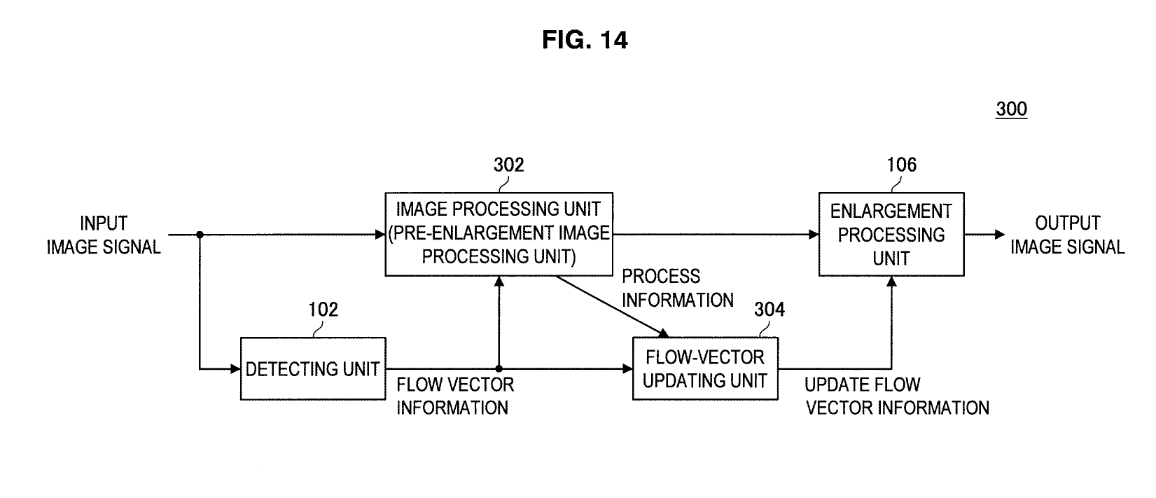

FIG. 14 is a block diagram showing an example of a configuration of the image processing apparatus 300 according to the third embodiment. The image processing apparatus 300 includes the detecting unit 102, an image processing unit 302 (a pre-enlargement image processing unit), a flow-vector updating unit 304, and the enlargement processing unit 106.

The image processing apparatus 300 according to the third embodiment shown in FIG. 14 basically has a configuration similar to that of the image processing apparatus 100 according to the first embodiment shown in FIG. 1. However, the image processing apparatus 300 according to the third embodiment further includes the flow-vector updating unit 304, as compared with the image processing apparatus 100 according to the first embodiment shown in FIG. 1. Further, in the image processing apparatus 300 according to the third embodiment, a function of the image processing unit 302 is different from that of the image processing unit 104 according to the first embodiment.

Although the image processing unit 302 has a configuration and a function that are basically similar to those of the image processing unit 104 according to the first embodiment, the image processing unit 302 is different from the image processing unit 104 according to the first embodiment in that the image processing unit 302 transmits process information that indicates a content of the process to the flow-vector updating unit 304. The process information according to the present embodiment includes information (that indicates coordinates of four corners, in case of a rectangular region) that indicates a region in which rendering is performed, and a process direction (the direction of brush strokes, for example) when the rendering is performed, for example.

The image processing unit 302 transmits process information that corresponds to all regions in which rendering is performed, to the flow-vector updating unit 304, regardless of whether rendering is performed according to a flow vector. However, a process performed by the image processing unit 302 is not limited to that described above. For example, the image processing unit 302 can be arranged to transmit process information corresponding to a region in which rendering is performed based on a user operation, that is, process information corresponding to a region in which an image process not corresponding to a flow vector is performed, to the flow-vector updating unit 304.

The flow-vector updating unit 304 updates a flow vector indicated by flow vector information transmitted from the detecting unit 102, for example, based on process information transmitted from the image processing unit 302. The flow-vector updating unit 304 transmits updated flow vector information that indicates a flow vector that is selectively updated based on the process information, to the enlargement processing unit 106.

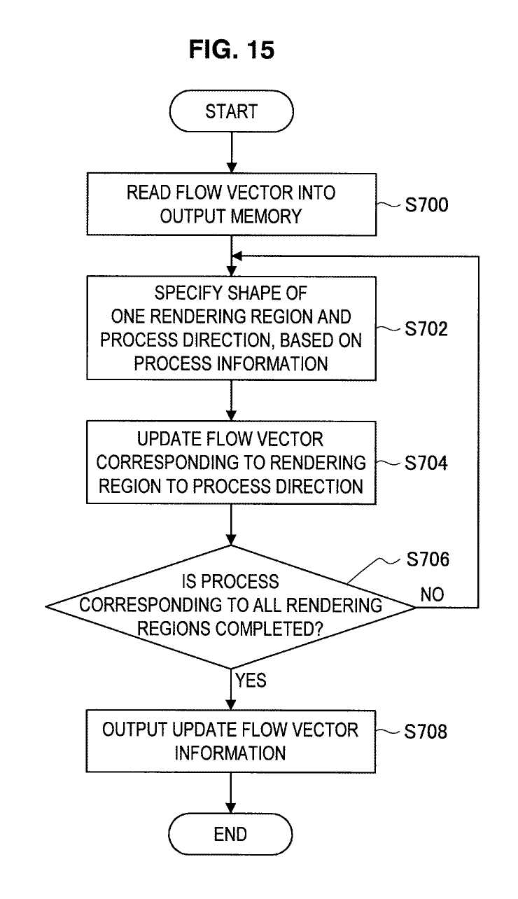

FIG. 15 is a flowchart showing an example of a process of the flow-vector updating unit 304 that is included in the image processing apparatus 300 according to the third embodiment.

The flow-vector updating unit 304 reads flow vectors indicated by flow vector information transmitted from the detecting unit 102, for example, into an output memory (S700).

The flow-vector updating unit 304 specifies a shape of one rendering region, and a process direction (the direction of brush strokes, for example), based on the process information transmitted from the image processing unit 302 (S702).

After the process of Step S702 is performed, the flow-vector updating unit 304 updates the flow vector corresponding to the specified rendering region to the specified process direction (S704).

After the process of Step S704 is performed, the flow-vector updating unit 304 determines whether a process corresponding to all rendering regions indicated by the transmitted process information is completed (S706). When it is not determined at step S706 that a process corresponding to all rendering regions is completed, the flow-vector updating unit 304 repeats the process of Step S702 afterward.

When it is determined at step S706 that a process corresponding to all rendering regions is completed, the flow-vector updating unit 304 outputs the updated flow vector information (S708), and ends the process.

The flow-vector updating unit 304 updates the flow vectors indicated by the flow vector information transmitted from the detecting unit 102, for example, based on the process information transmitted from the image processing unit 302, by performing the process shown in FIG. 15, for example. It is needless to mention that a process performed by the flow-vector updating unit 304 according to the present embodiment is not limited to the process shown in FIG. 15.

The image processing apparatus 300 according to the third embodiment has a configuration as shown in FIG. 14 which is similar to the configuration of the image processing apparatus 100 according to the first embodiment shown in FIG. 1, for example. Therefore, the image processing apparatus 300 can convert an image indicated by an image signal to be processed into an image that has a larger number of pixels than that of an image processed based on flow vectors, by performing the process (the image process based on flow vectors) of (1) and the process (the enlargement process) of (2) according to the image processing method according to the present embodiment.

The image processing apparatus 300 updates the flow vectors transmitted from the detecting unit 102, for example, based on the process information transmitted from the image processing unit 302 that performs the process (the image process based on flow vectors) of (1). Therefore, the image processing apparatus 300 becomes possible to relate the processed image to the flow vectors, and consequently, can prevent potential degradation of image quality when the processed image is not related to the flow vectors.

### A Modification of a Configuration of the Image Processing Apparatus 300 According to the Third Embodiment

A configuration of the image processing apparatus 300 according to the third embodiment is not limited to the configuration shown in FIG. 10. For example, the image processing apparatus 300 according to the third embodiment can have a modification similar to that of the image processing apparatus 100 according to the first embodiment.

The image processing apparatus 300 according to the third embodiment can be configured to perform plural image processes based on flow vectors, in a similar manner to that of the image processing apparatus 200 according to the second embodiment (including the modification). In case of taking the configuration described above, the image processing apparatus 300 according to the third embodiment includes a flow-vector updating unit that updates a flow vector based on process information transmitted from each image processing unit, at a latter stage of each image processing unit.

As explained above, the image processing apparatus according to the present embodiment performs the process (the image process based on flow vectors) of (1) and the process (the enlargement process) of (2). In this case, the image processing apparatus according to the present embodiment performs an image process based on flow vectors, to an image of which a number of pixels is smaller than an image of a desired number of pixels obtained by the process (the enlargement process) of (2), in the process (the image process based on flow vectors) of (1). Therefore, the image processing apparatus according to the present embodiment can reduce a calculation amount that is necessary to perform the image process based on flow vectors, and consequently, can shorten a time necessary to perform the image process based on the flow vectors.

The image processing apparatus according to the present embodiment performs a process using flow vectors that is used for the process (the image process based on flow vectors) of (1), in the process (the enlargement process) of (2). Therefore, the image processing apparatus according to the present embodiment is not necessary to newly detect a direction component in the image, unlike a case where the technique relating to the enlargement process as described in Japanese Patent No. 4150947 and in the non-patent literatures 4 and 5 is used, for example. Consequently, a processing time is not extended to detect a direction component of the image unlike a case where the technique relating to the enlargement process is used. Because the image processing apparatus according to the present embodiment performs the enlargement process by using a flow vector that is used in the process of (1), there is no risk of degradation of image quality, unlike a case where the technique relating to the enlargement process as described above is used.

Therefore, the image processing apparatus according to the present embodiment can convert an image indicated by an image signal to be processed into an image that has a larger number of pixels than that of an image processed based on flow vectors, while shortening the processing time and preventing degradation of image quality.

Although the image processing apparatus 100 is explained above as the present embodiment, the present embodiment is not limited to this embodiment. The present embodiment can be applied to various apparatuses, such as an image pickup apparatus including a digital camera, a display apparatus including a computer such as a PC (Personal Computer) and a tablet terminal, a communication apparatus including a portable telephone, a video/music reproducing apparatus (or a video/music recording/reproducing apparatus), a game machine, and a display device including a television receiving apparatus,. The present embodiment can be also applied to an image processing IC (Integrated Circuit) that can be assembled in the apparatuses described above, for example.

### A Program According to the Present Embodiment

It is possible to convert an image indicated by an image signal to be processed into an image that has a larger number of pixels than that of an image processed based on flow vectors, by a program that causes a computer to function as the image processing apparatus according to the present embodiment (a program that makes the computer to execute a process relating to the image processing method according to the present embodiment, such as the process (the image process based on flow vectors) of (1) and the process (the enlargement process) of (2), for example).

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, although it is described above that a program (a computer program) that causes a computer to function as the image processing apparatus according to the present embodiment is provided, the present embodiment can also provide recording mediums that respectively store the programs described above.

The aforementioned configurations are merely illustrative of this embodiment. Naturally, such configurations are within the technical scope of the present disclosure.

Additionally, the present technology may also be configured as below.

(1)

An image processing apparatus including:

a pre-enlargement image processing unit that processes an image signal, based on a one or more flow vectors corresponding to the image signal; and

an enlargement processing unit that enlarges an image indicated by an image signal processed by the pre-enlargement image processing unit, based on the one or more flow vectors.

(2)

The image processing apparatus according to (1), further including a detecting unit that detects one or more flow vectors corresponding to the image, based on the image signal.

(3)

The image processing apparatus according to (1),

wherein the one or more flow vectors corresponding to the image is set based on a user operation.

(4)

The image processing apparatus according to any one of (1) to (3),

wherein the enlargement processing unit

calculates a flow vector corresponding to a position of an interpolated pixel for interpolating in case of performing enlargement, for each interpolated pixel, based on a corresponding flow vector among the one or more flow vectors, and

obtains a pixel value of each interpolated pixel, based on the flow vector corresponding to each position of a calculated interpolated pixel, and on the processed image signal.

(5)

The image processing apparatus according to (4), further including an post- enlargement image processing unit that processes an image signal indicating an enlarged image, based on a set of flow vectors corresponding to the image and a flow vector corresponding to each position of a calculated interpolated pixel.

(6)

The image processing apparatus according to any one of (1) to (5), further including a flow-vector updating unit that updates at least one of the flow vectors corresponding to the image, based on process information that indicates a content of a process performed by the pre-enlargement image processing unit,

wherein the enlargement processing unit enlarges an image indicated by the image signal processed, based on one or more updated flow vectors.

(7)

The image processing apparatus according to any one of (1) to (6), wherein

the pre-enlargement image processing unit

specifies a pixel for smoothing an image indicated by the image signal, based on the one or more flow vectors, and

smoothes an image indicated by the image signal, based on a specified pixel.

(8)

An image processing method including:

processing an image signal, based on one ore more flow vectors corresponding to the image signal; and

enlarging an image indicated by a processed image signal, based on the one or more flow vectors.

A program that causes a computer to execute:

processing an image signal, based on one or more flow vectors corresponding to an image indicated by the image signal; and

enlarging an image indicated by a processed image signal, based on the one or more flow vectors.

The present disclosure contains subject matters related to that disclosed in Japanese Priority Patent Application JP 2011-098443 filed in the Japan Patent Office on Apr. 26, 2011, the entire content of which is hereby incorporated by reference.

What is claimed is:

1. An image processing apparatus comprising:
a pre-enlargement image processing unit that processes an image signal, based on a one or more flow vectors corresponding to the image signal; and
an enlargement processing unit that enlarges an image indicated by an image signal processed by the pre-enlargement image processing unit, based on the one or more flow vectors.

2. The image processing apparatus according to claim 1, further comprising a detecting unit that detects one or more flow vectors corresponding to the image, based on the image signal.

3. The image processing apparatus according to claim 1,
wherein the one or more flow vectors corresponding to the image is set based on a user operation.

4. The image processing apparatus according to claim 1,
wherein the enlargement processing unit
calculates a flow vector corresponding to a position of an interpolated pixel for interpolating in case of performing enlargement, for each interpolated pixel, based on a corresponding flow vector among the one or more flow vectors, and
obtains a pixel value of each interpolated pixel, based on the flow vector corresponding to each position of a calculated interpolated pixel, and on the processed image signal.

5. The image processing apparatus according to claim 4, further comprising an post- enlargement image processing unit that processes an image signal indicating an enlarged image, based on the one or more flow vectors corresponding to the image and a flow vector corresponding to each position of a calculated interpolated pixel.

6. The image processing apparatus according to claim 1, further comprising a flow- vector updating unit that updates the at least one of the flow vectors corresponding to the image, based on process information that indicates a content of a process performed by the pre-enlargement image processing unit,
wherein the enlargement processing unit enlarges an image indicated by the image signal processed, based on one or more updated flow vectors.

7. The image processing apparatus according to claim 1, wherein
the pre-enlargement image processing unit
specifies a pixel for smoothing an image indicated by the image signal, based on the one or more flow vectors, and
smoothes an image indicated by the image signal, based on a specified pixel.

8. An image processing method comprising:
processing an image signal, based on one or more flow vectors corresponding to the image signal; and
enlarging an image indicated by a processed image signal, based on the one or more flow vectors.

9. A program that causes a computer to execute:
processing an image signal, based on one or more flow vectors corresponding to an image indicated by the image signal; and
enlarging an image indicated by a processed image signal, based on the one or more flow vectors.
